(19) United States
(12) Patent Application Publication
(10) Pub. No.: US 2009/0322652 A1
(43) Pub. Date: Dec. 31, 2009

(54) SYSTEM FOR PROJECTING USER INPUT ON MULTIPLE THIRD PARTY VIEWABLE SCREENS SIMULTANEOUSLY

(76) Inventors: Peter Adderton, Newport Coast, CA (US); Scott M. Anderson, Newport Beach, CA (US); Michael T. McSherry, Seattle, WA (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 12/489,035

(22) Filed: Jun. 22, 2009

Related U.S. Application Data
(60) Provisional application No. 61/074,320, filed on Jun. 20, 2008.

(51) Int. Cl. G09G 5/00

(52) U.S. Cl. 345/2.3

(57) ABSTRACT

An inventive system and method for projecting user input on multiple third party viewable screens simultaneously is presented. The method comprises establishing an identity on the network and associating the identity with an identifier, uploading content onto the network using an apparatus, associating the content with the identifier, and distributing and projecting the uploaded content and the identifier to a plurality of devices simultaneously. The apparatus can be a mobile device, a game controller, iTV, or a computer. The devices can be mobile devices, game controllers, iTVs, TVs, event big screens, and computers. The user input can be text, SMS, email, and voice message. In one embodiment, establishing an identity includes logging-in to the network, registering, and selecting the identifier. Users of the devices can respond to the distributed content.

### RELATED APPLICATION

This application claims priority to a provisional application titled “SYSTEM FOR PROJECTING USER INPUT ON MULTIPLE THIRD PARTY VIEWABLE SCREENS SIMULTANEOUSLY” filed on Jun. 20, 2008, and having an Application Ser. No. 61/074,320.

### FIELD OF THE INVENTION

The present invention relates generally to broadcasting messages. In particular, the invention relates to projecting a message from a user connected to the internet or any telecommunications network on a variety of third party viewable screens simultaneously, and enabling other users to interact with this projected message.

### BACKGROUND OF THE INVENTION

The internet has created a whole new way of letting everyone have their say on any topic. For example, bloggers now have a real and truly powerful influence on celebrities, CEO's, politicians and others like never before. Coactive media offers various forms of interactive media content. More specifically, coactive television (TV) is the multitasking use of both television and other interactive media, such as the Internet, such that a TV program on a TV screen is coordinated or synchronized with Internet activities on a computer screen. For example, interactive TV (iTV) offers a user the ability to provide feedback to a broadcast television program.

However, there is a need for a system that provides a user with the ability to make comments on anything and everything directly from the user's mobile phone or computer or any other input device connected to the internet or any telecommunications network, and have these comments or messages projected live to one or more third party viewable screens simultaneously.

### SUMMARY OF THE INVENTION

The present invention advantageously provides a system that projects user input messages on a variety of third party viewable screens simultaneously. The ability to multi-text to multiple screens is provided. An AVATAR or other user identification in graphical or textual form is displayed to identify each message on each screen. The avatar identifies the message sender and is connected to and/or coordinated with the phone number of the message sender. The avatar can also attach to emails. The system enables social networking as well as anti-social networking in conjunction with the avatar-identified text messages. The system also includes the capability to monitor and screen messages for inappropriate content. Additionally, users can call a phone number and leave a voice message. This voice message will be translated from ‘voice to text’ via software translation tools and human heuristic review. These text messages will then also be forwarded to the various screens for display and can be associated with the avatar identity.

The inventive system and method comprises establishing an identity on the network and associating the identity with an identifier, uploading content onto the network using an apparatus, associating the content with the identifier, and distributing and projecting the uploaded content and the identifier to a plurality of devices simultaneously. The apparatus can be a mobile device, a game controller, iTV, or a computer. The devices can be mobile devices, game controllers, iTVs, TVs, event big screens, and computers. The user input can be text, SMS, email, and voice message. The identifier can be an avatar, a picture, a graphical icon, and “guest”. In one embodiment, establishing an identity includes logging-in to the network, registering, and selecting the identifier. Users of the devices can respond to the distributed content.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a schematic illustration of the present invention;

FIG. 2 illustrates messages projected at home on a PC;

FIG. 3 illustrates messages projected online;

FIG. 4 illustrates messages projected on a public video billboard;

FIG. 5 illustrates messages projected in a bar;

FIG. 6 illustrates messages projected on TV;

FIG. 7 illustrates messages projected via Facebook;

FIG. 8 illustrates messages projected at a stadium;

FIG. 9 illustrates messages projected on a mobile device;

FIG. 10 is an advertisement used on iTV;

FIG. 11 illustrates an exemplary system architecture;

FIG. 12 is a flow diagram of the steps carried out by the present invention;

FIG. 13 shows sample screens of the inventive system;

FIG. 14 illustrates video insertion technology in accordance with the present invention; and

FIG. 15 is an exemplary screen on which STTV is active.

The foregoing and other objects, aspects, features, advantages of the invention will become more apparent from the following description and from the claims.

### DISCLOSURE OF THE INVENTION

The inventive system provides a novel technique that uses both fixed and mobile devices connected either to a wired or wireless network and brings together various types of media, enabling the projection of messages from the devices on multiple screens simultaneously. A consumer oriented approach to media usage results. The devices can be, for example, computers, other keyboard input devices, mobile phones or cell phones, as well as other devices capable of transmitting communications, such as voice messages and/or short message service (SMS) or text messages.

Mobile technologies provide immediate feedback. The mobile phone, for example, can be considered to be a “reverse channel”, providing immediate feedback for television shows, commercials, and on-air promotions. Immediate response rates can be obtained and customer relationship manager (CRM) opportunities are offered. New revenue streams are opened in accordance with this approach. For example, on one television show, forty percent of all voting participants sent more than three SMS per week.

General trends in interactive TV (iTV) include premium SMS revenues to help finance TV production and increase profit. Due to high audience involvement, consumer brands find iTV an attractive environment for sponsorship. Sweepstakes and other participative formats provide additional sponsorship opportunities, which add incremental revenue. The mobile channel supports the core media business by binding nearly all ages and targets and by improving viewer loyalty. Media companies require reliability and scalability to process millions of interactions per show. Consumers quickly adopt and repeat interaction opportunities, which translates to reliable revenue streams.

The inventive system, referred to herein as Smack Talk™ TV or STTV, is media-agnostic: television, iTV, event big screen, computer, cell phone, i.e. any screen, anywhere that displays the STTV logo. STTV allows a user to create a personal alter-ego with complete anonymity via easy-to-build avatars at the STTV web site.

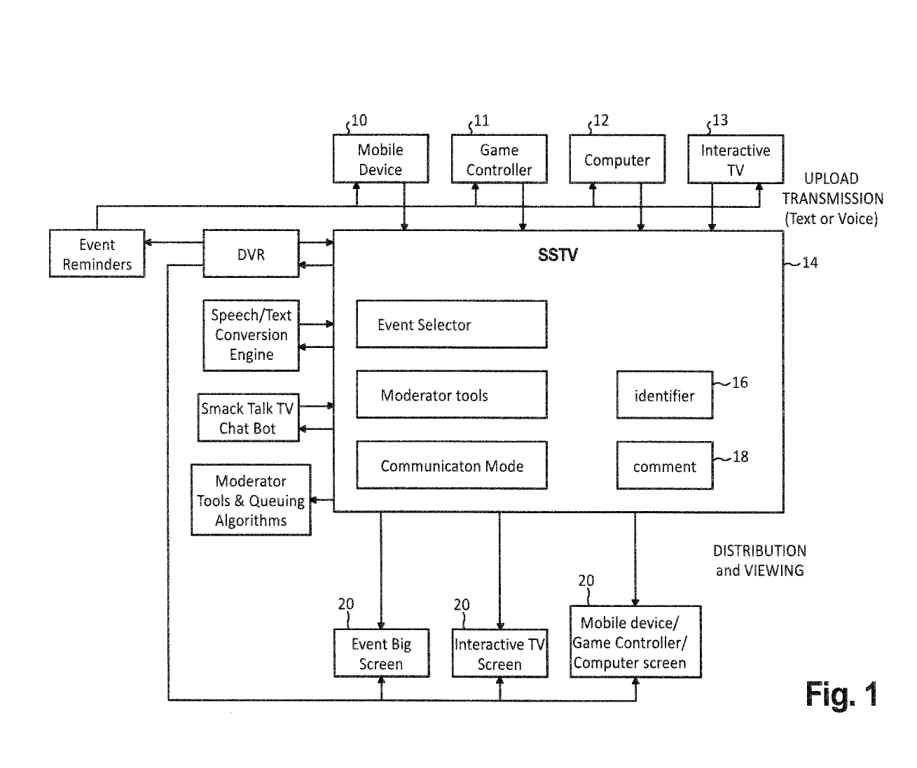

FIG. 1 is a schematic diagram of the inventive system. A variety of apparatuses or devices, including a mobile communication device 10, e.g., mobile telephone, PDA, etc., a game controller 11, a computer 12, e.g., a personal computer, a laptop computer, a notebook computer, etc., and iTV 13 can be used to access STTV 14. STTV 14 provides many features and functions, including avatar selector, comment routing, event selector, moderator tools, and communication mode having user voice, text, computer voice and recorded voice.

Initially a user registers with STTV 14 and creates an identity associated with an identifier 16, such as personal avatar or a photograph, picture or graphic icon. In one embodiment, the user enters the system with an identifier of “guest”. After registering, a user can participate by inputting and uploading information or content, that is by posting comments or messages 18. These postings can be projected simultaneously on various screens 20, such as mobile device, game controller, and/or other type of computer screen, a TV screen, an iTV screen, an event big screen or other LCD viewing screen. The user's message 18 will always appear with his or her personal avatar 16. Once a user has created his or her own avatar 16 and registered at STTV 14, as soon as the user logs in to a Smack Session and inputs content, the avatar 16 will automatically appear alongside any and all content or messages 18. Hence, a user's mobile phone or computer becomes his or her voice to millions of people, and the avatar 16 becomes “a star”. The Smack Session can be commenting on the material displayed on the screen, commenting on the comments of other users, chatting in a chat room, social networking, and/or anti-social networking. Other Smack Session types can also be logged into by a user.

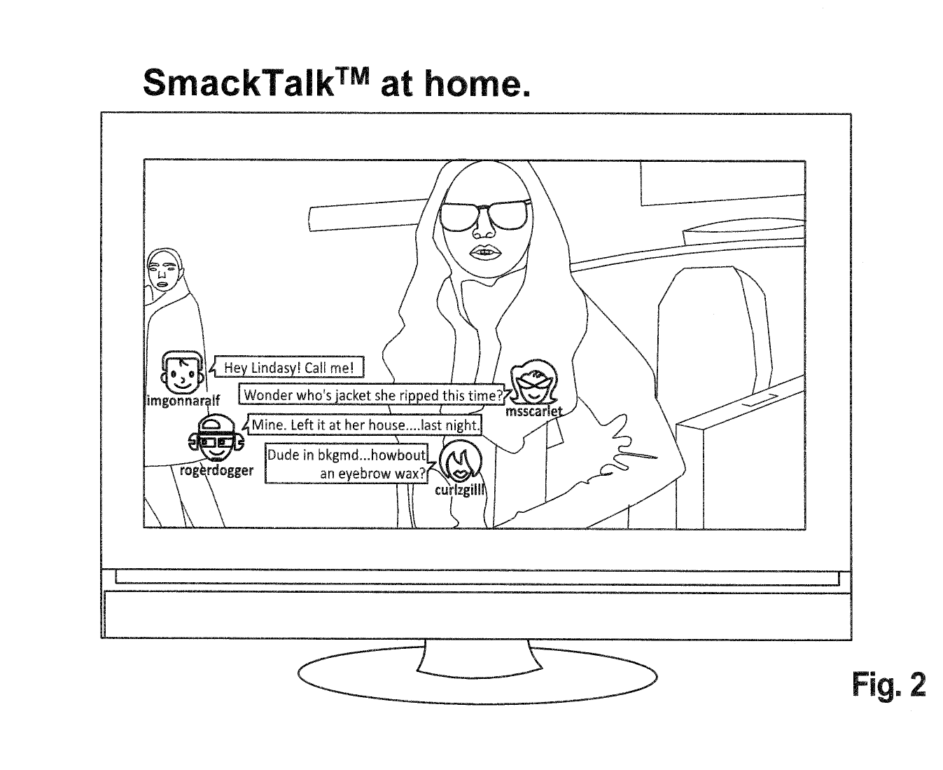

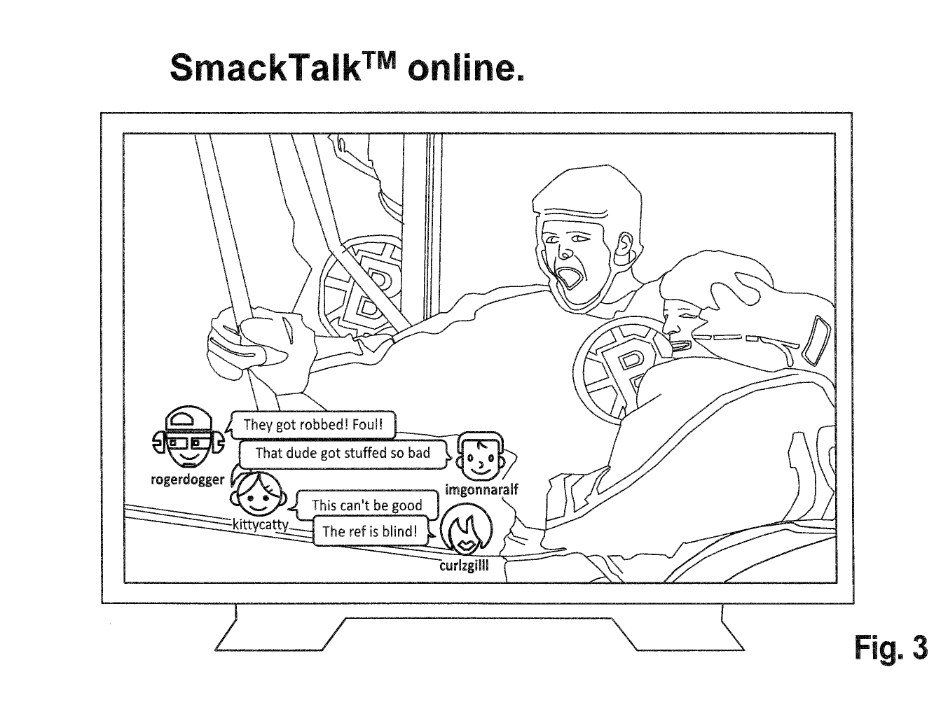

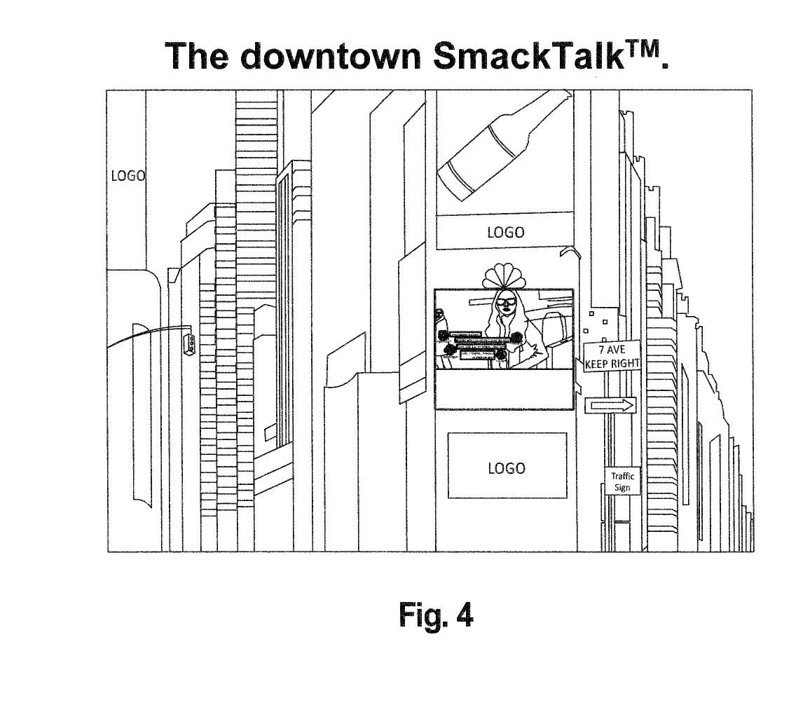

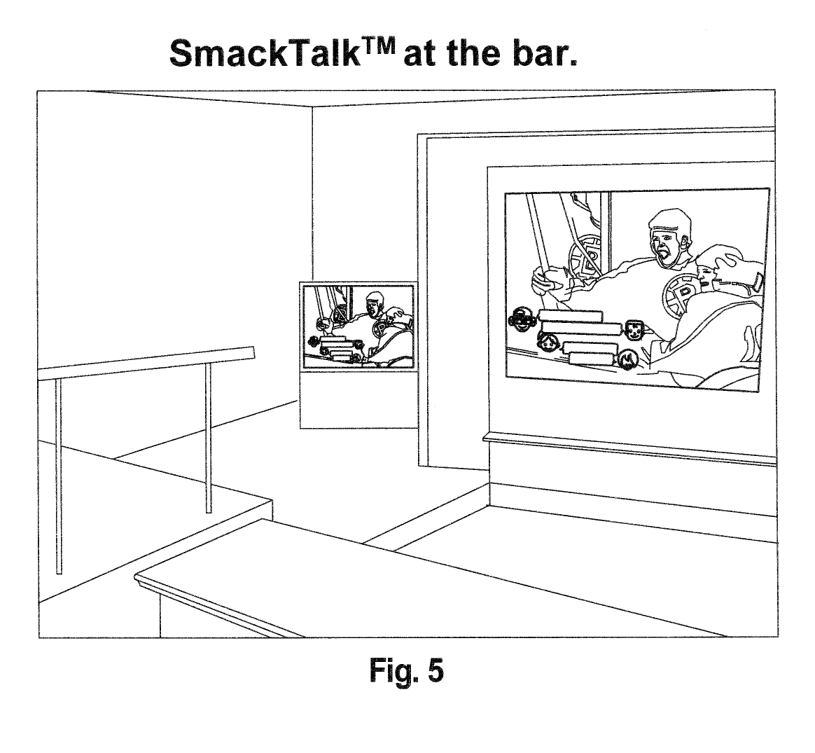

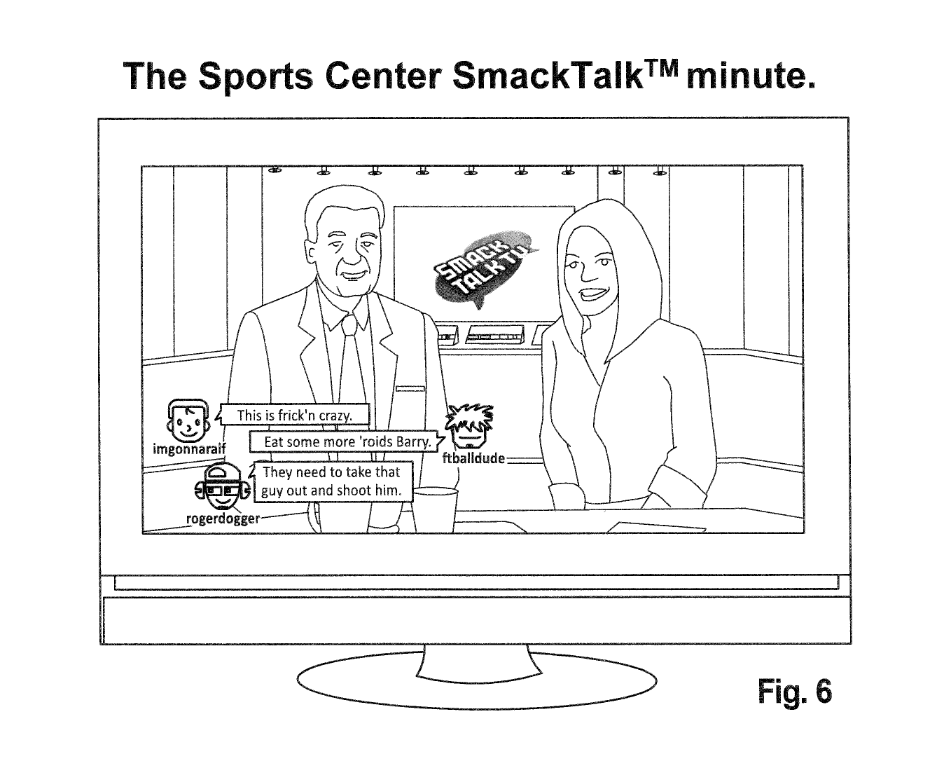

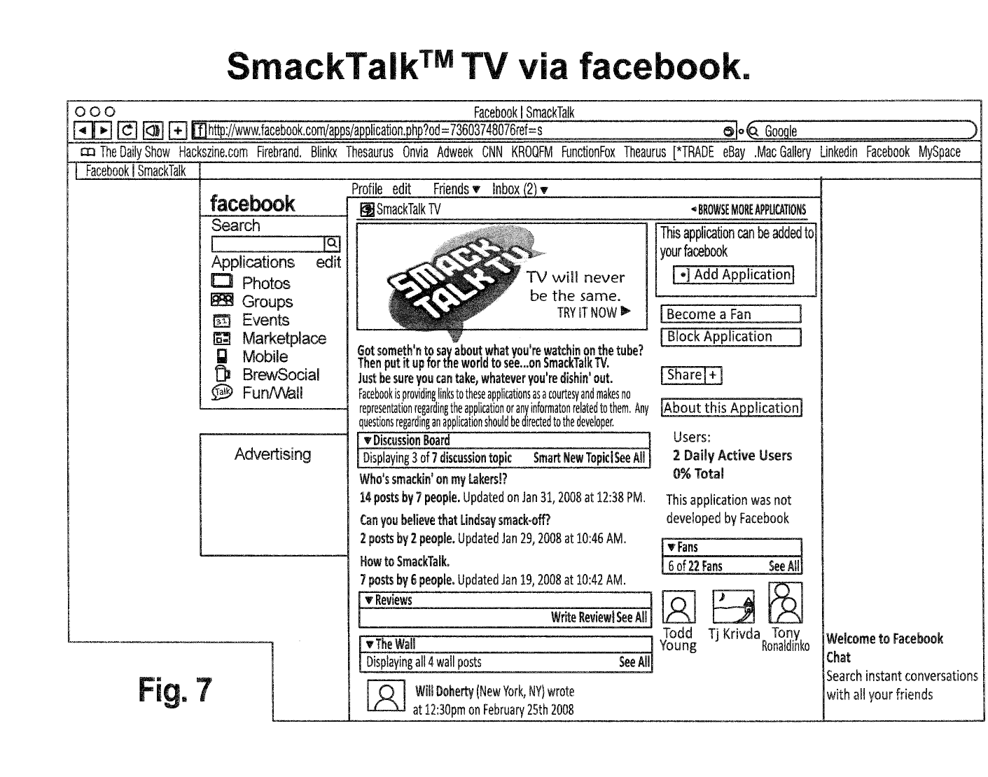

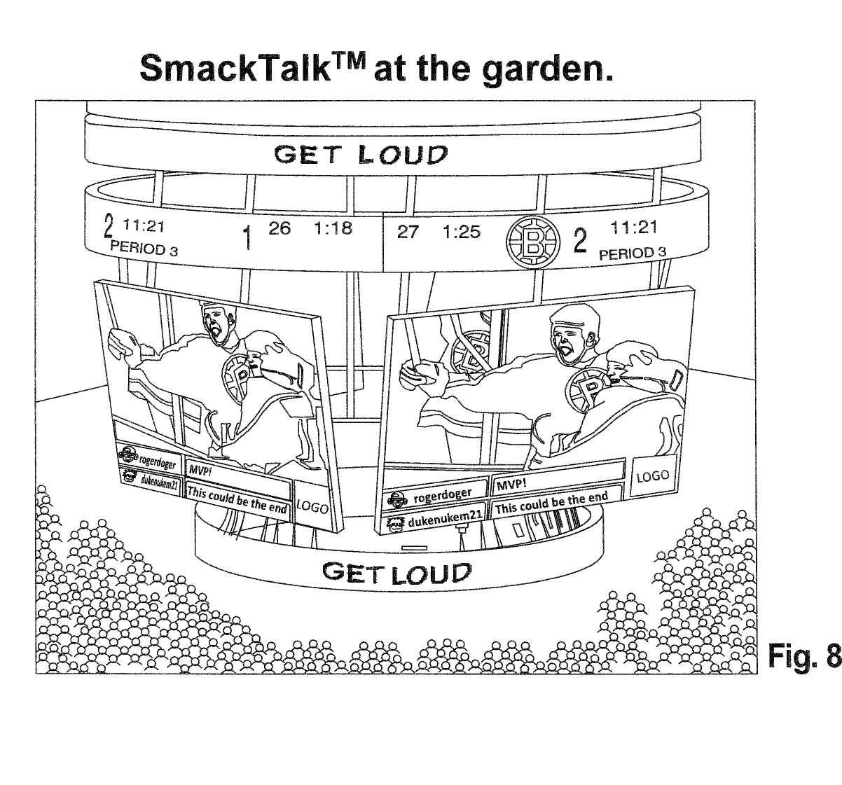

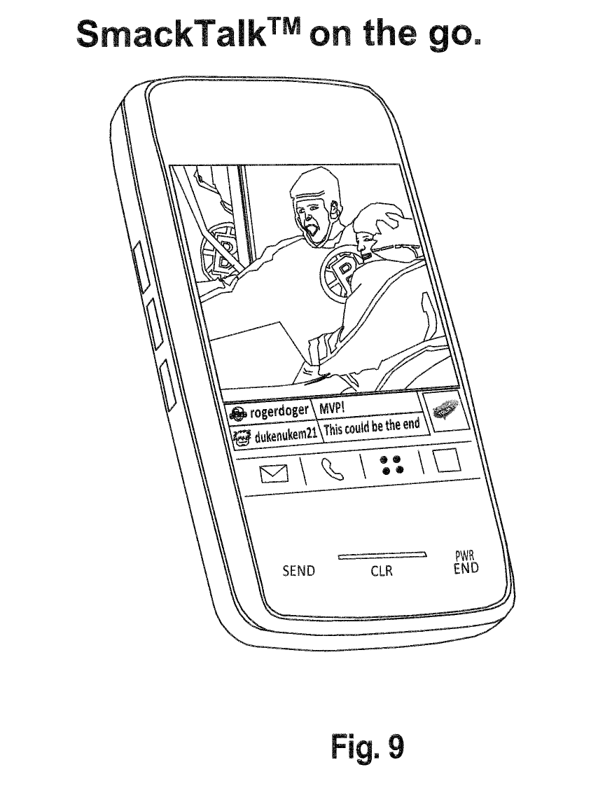

A user can participate virtually anywhere, including on TV, on a mobile device 10, on a computer 12, on a game controller 11, on iTV 13, on an on-premise application, i.e., restaurant or bar, or on another out-of-home application, i.e., a stadium or other sports facility application. User participation is illustrated in FIGS. 2-9. FIG. 2 illustrates Smack Talk™ at home on a PC. FIG. 3 illustrates Smack Talk™ online. FIG. 4 illustrates Smack Talk™ on a public video billboard. FIG. 5 illustrates Smack Talk™ in a bar/restaurant. FIG. 6 illustrates Smack Talk™ on TV. FIG. 7 illustrates Smack Talk™ TV via Facebook. FIG. 8 illustrates Smack Talk™ at a stadium. FIG. 9 illustrates Smack Talk™ on a mobile device. STTV will always have a variety of different content available for comment, including images, videos, or just plain old inflammatory user comments.

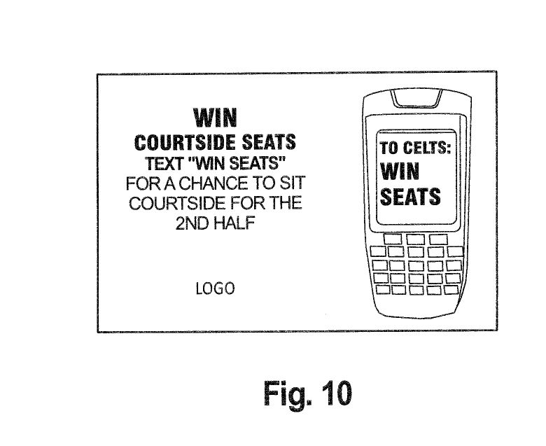

An example of iTV interaction follows. According to Zing Media Consulting, when the National Basketball Association (NBA) presented an advertisement to “win courtside seats by texting to CELTS”, shown in FIG. 10, a very favorable response was obtained. The NBA's objective was fourfold: to increase ticket sales for future games via mobile communication, to engage fans through the innovative mobile channel, to generate excitement at NBA games, and to motivate fans to watch more games. The result of this advertisement was approximately eight percent of the people watching used the service, i.e. an 8% take rate, based on an official attendance of 18,526 people generating 1,704 entries from 1,500 unique users.

STTV employs text-to-screen processes. STTV provides a variety of features, including live, interactive, moderated chat. Audience members or users enter their opinions and/or statements as a text or voice message, sent by SMS to a short code (texted code to access an application or content) or service number. Profanity is filtered, and a moderator (TJ) controls controversial chat. Multiple chat rooms can be created. The audience can continue the chat after the TV show ends.

In one embodiment, the host or moderator answers questions as they are received. Other interactive offers, such as voting, can be incorporated into the chat scenario. Billing can be performed using Premium SMS. Comprehensive and real-time statistics are available on a secure website.

Smack Talk™ Studios can have real-time, live programmers reading and pushing texts in mere seconds to any screen where the STTV service is available. Onsite, at large events, live-to-air STTV broadcast vans can be used outside the event to create and control the experience. All un-edited comments can be posted on the website, even if these comments are not presented on the screen, so a user's opinion will always be heard.

The inventive system offers easy registration of the computer or mobile application. The capability can be added to MySpace or Facebook pages, and used as shown in FIG. 7.

The system can be used whenever it is valuable or entertaining to be able to display a virtual “conversation” about any material that can be displayed on a screen connected to a network. Other uses may include a live pop culture show, with real-time pop-up comments for the duration of the show, live sporting events on the big screen at half-time shows, and/or before the event begins. For example, FIG. 8 shows trash-talking 80,000 or more people in real-time at a live sporting event.

During sports half-time shows on ESPN, primetime NBC or even during re-runs of Happy Days, STTV will be there. In addition, STTV can be found live on a cell phone, as shown in FIG. 9, live on a computer screen, as shown in FIG. 2, and/or in the cinema while waiting for a movie to begin, as well as live in a fully interactive TV program. The inventive system may be broadly useful in business applications, when multiple participants at disparate locations using a variety of wired or wireless input devices can benefit from commenting and interacting about material displayed on a screen in the form of video, graphics, or text. Accordingly, the inventive system combines mobile phone portability with the ability to instantly, and simultaneously, make comments on multiple screens.

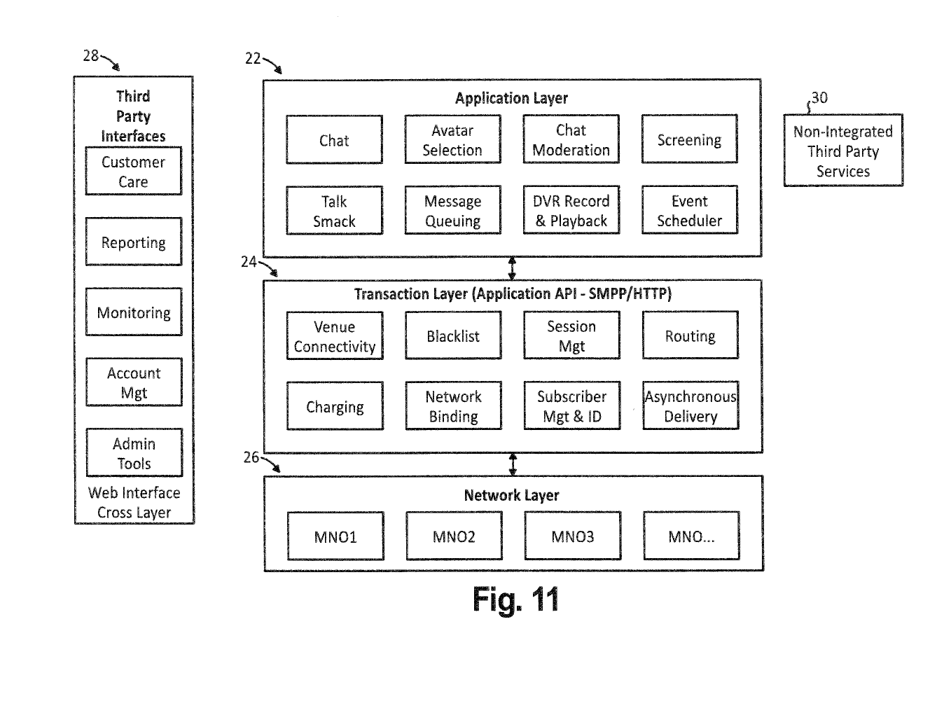

An exemplary system architecture is shown in FIG. 11. An application layer 22 contains various applications including chats, avatar, chat moderation, screening, talk smack, message queue, DVR record & playback, and event schedule. A transaction layer 24 includes application API (SMPP/HTTP) and can contain functions such as venue connectivity, blacklist, session management, routing, charging, network binding, subscriber management and identification, and asynchronous delivery, among others. A network layer 26 includes MNO1, MNO2, MNO3, MNO, among others. A web-interface cross layer 28 contains third party interfaces, and a variety of modules or applications including customer care, reporting, monitoring, account management and administration or administration tools. Non-integrated services 30 as well as third party services 30 can be made available at the application layer 22.

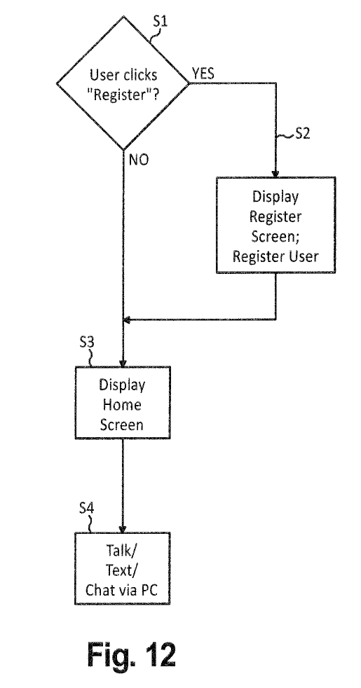

The operation of the system is shown in the flow diagram of FIG. 12. Initially, a user is either registered or not. The user enters a user name and password, and clicks either Register or Login. If the user clicks on register (S1=YES), a Registration Screen is displayed and the registration process occurs in step S2. During this process, the user supplies numerous data items including screen name/password/age/email/mobile phone number, and clicks either Back or Next. If Next is selected, a New Avatar Screen displaying Build Your Own Avatar is displayed. The user creates an avatar and clicks Home or Save.

The Home Screen is displayed in step S3 if Home is selected from Avatar screen, or if Login is selected from Log In Screen (S1=NO). The Home Screen can include the STTV LOGO, the screen/user name, the related AVATAR and search box, various buttons, such as My Profile, etc., and Smack Talk™ TV Session Categories: Sports, Broadcast TV, Cable Networks, Events, One-on-ones, I'm Feeling Lucky. The user clicks on the desired button to select it, and then clicks select.

In step S4, the user commences talking and/or texting and/or communicating using the internet. Based on the user's selection on the Home Screen, an appropriate screen for the communication is displayed. Some screen options are My Profile Screen, Event Smack Session Screen, I'm Feeling Lucky Screen, Select a Smack Talk™ TV Opponent, Opponent Selector Screen. Operations in step S4 can include shortcode management, message routing, context filtering, network authentication, campaign tools and/or management, technical support and care. Additional operations can include maintenance and updating of a registration database, billing services, revenue reconciliation, and reporting. Unregistered users, e.g., guests, can participate in STTV 14; their comments 18 are displayed without an avatar 16 (see FIG. 16 below). An unregistered user can log in to the system by entering GUEST as the user name on the Log In Screen.

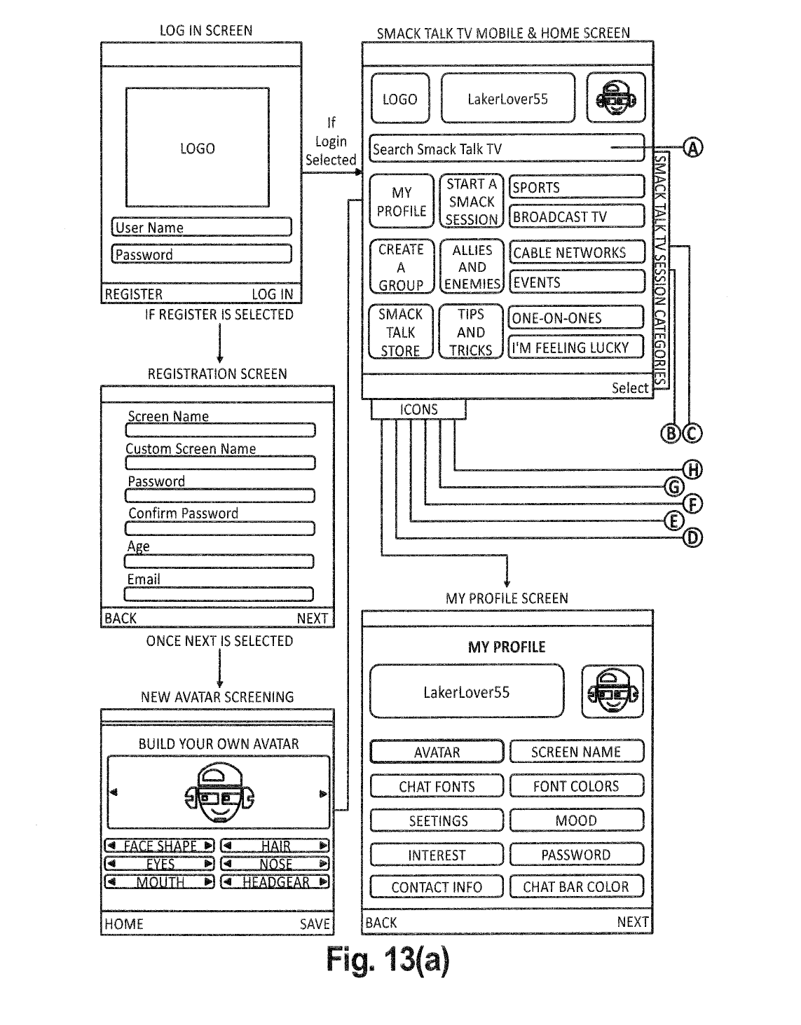

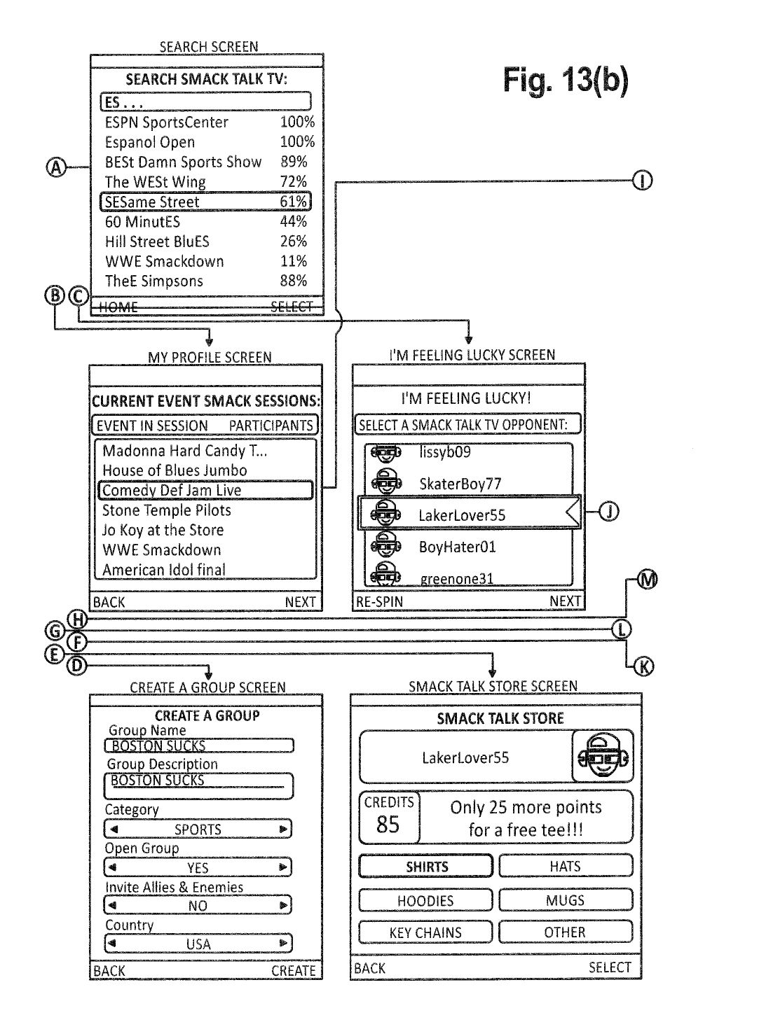

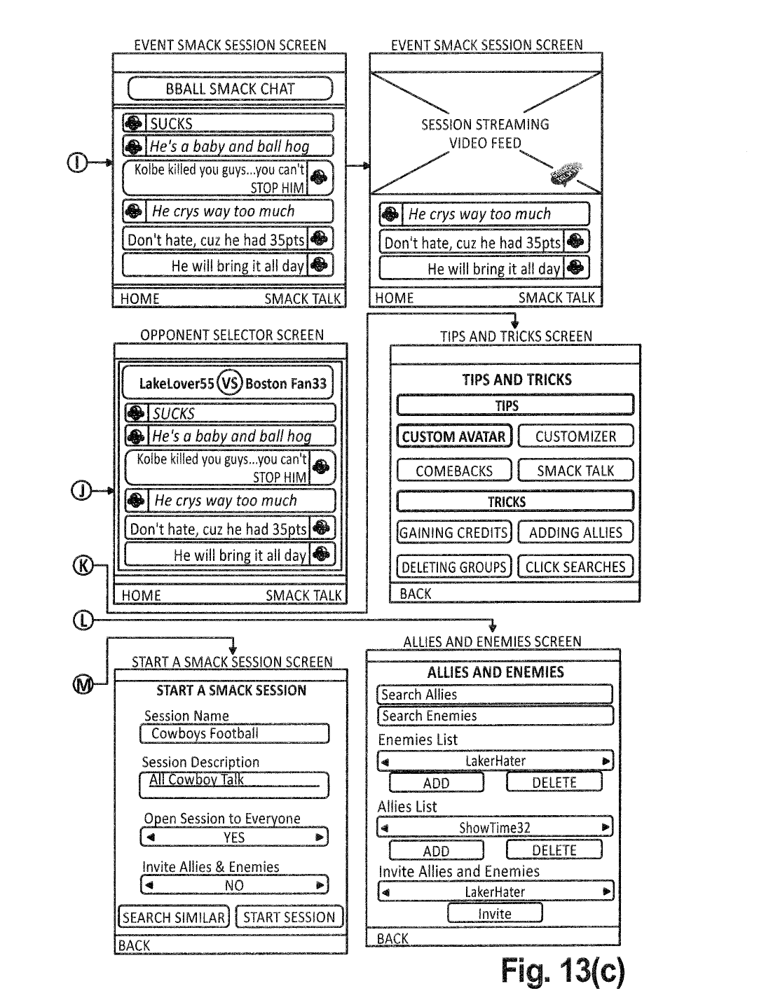

FIG. 13 illustrates exemplary screens for the inventive system. These screens can include Log In Screen, Registration Screen, New Avatar Screen, and Smack Talk™ Mobile Home Screen (“Home Screen”). As shown in FIG. 13, from the Home Screen, one can access screens such as My Profile Screen, Create a Group Screen, Smack Talk™ Store Screen, Start a Smack Session Screen, Allies and Enemies Screen, Tips and Tricks Screen, and Smack Talk™ TV Session. In addition, from the Home Screen, one can search STTV using the Search Smack Talk™ TV screen. Also, various Smack Talk™ Session Categories can include screens shown in FIG. 13, such as Event Smack Session Screen, My Profile/Current Event Smack Sessions Screen, I'm Feeling Lucky Screen, and Opponent Selector Screen.

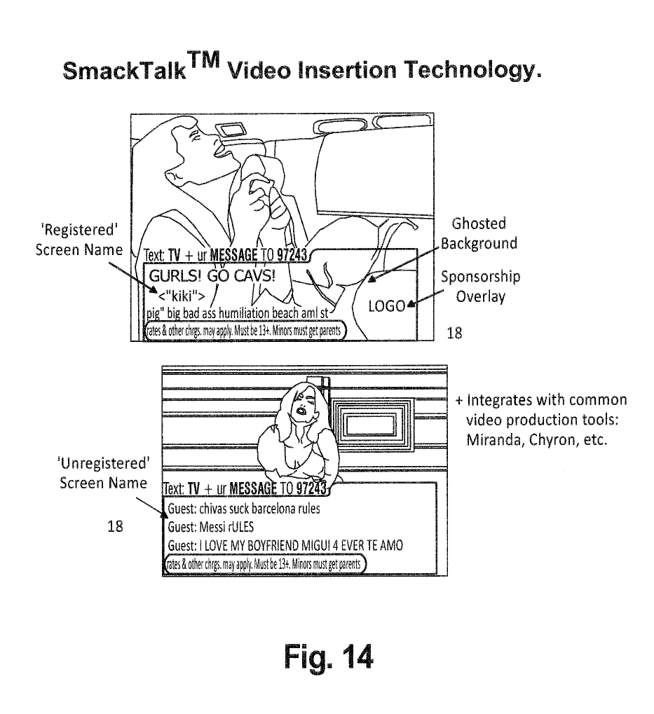

FIG. 14 shows a video insertion technology employed in one embodiment of the invention. Also shown are user comments 18. STTV 14 integrates with various video production tools, including Miranda, Chyron and others. As shown in FIG. 14, a ghosted background can be projected onto a screen, along with a sponsorship overlay, such as Toyota.

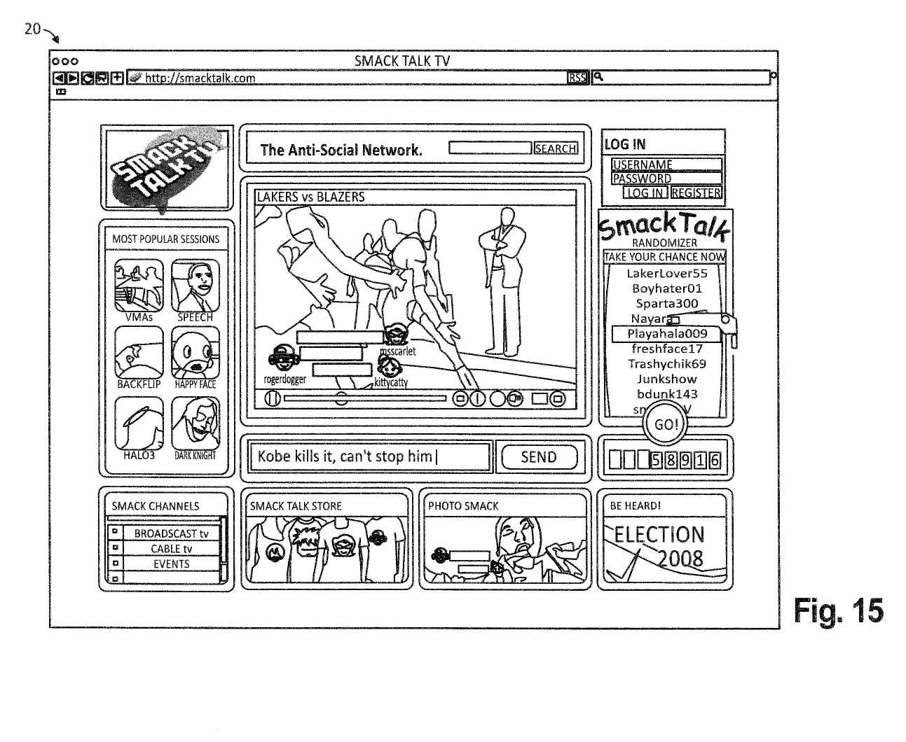

FIG. 15 is an illustrative screen 20 on which the system is active. The left side of the screen displays popular sessions a user can join and start chatting. The middle section shows a video, which is the live show being simulcast on sstv.com and on the mobile device. User comments 18 identified with avatars 16 may appear on this portion of the screen. The right hand side includes a randomizer; when a user clicks on “go”, the system randomly picks another user with whom the clicking user can exchange remarks. Across the bottom are available channels and subjects, such as Smack Talk™ Store, Photo Smack, etc. In addition, a user can upload his or her photos and videos to his or her Smack Talk™ site profile and have people comment, such as “are you hot or not”.

The invention can be implemented as computer software or a computer readable program for operating on a computer. The computer program can be stored on computer readable medium in a computer. Various aspects of the present disclosure may be embodied as a program, software, or computer instructions embodied in a computer or machine usable or readable medium, which causes the computer or machine to perform the steps of the method when executed on the computer, processor, and/or machine.

System and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The term “computer system” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for displaying content on multiple third party viewable screens over a network, said method comprising steps of:
establishing an identity on the network and associating the identity with an identifier;
uploading content onto the network using an apparatus;
associating the content with the identifier; and
distributing and projecting the uploaded content and the identifier to a plurality of devices simultaneously.

2. The method according to claim 1, wherein the apparatus is one of a mobile device, a game controller, iTV, and a computer.

3. The method according to claim 1, wherein each of the plurality of devices is one of a mobile device, a game controller, iTV, a TV, an event big screen, and a computer.

4. The method according to claim 1, wherein the content is at least one of text, SMS, email, and a voice message.

5. The method according to claim 1, wherein the identifier is one of an avatar, a picture, a graphical icon, and guest.

6. The method according to claim 1, wherein the step of establishing an identity further comprises steps of:
logging-in to the network;
registering; and
selecting the identifier.

7. The method according to claim 1, wherein users of one or more of the plurality of devices respond to the distributed content.

8. A system for displaying content on multiple third party viewable screens over a network, said system comprising:
an identity established on the network and associated with an identifier;
an apparatus for uploading content onto the network, said content associated with the identifier; and
a plurality of devices projecting the uploaded content and the identifier simultaneously.

9. The system according to claim 8, wherein the apparatus is one of a mobile device, a game controller, iTV, and a computer.

10. The system according to claim 8, wherein each of the plurality of devices is one of a mobile device, a game controller, iTV, a TV, an event big screen, and a computer.

11. The system according to claim 8, wherein the content is at least one of text, SMS, email, and a voice message.

12. The system according to claim 8, wherein the identifier is one of an avatar, a picture, a graphical icon, and guest.

13. The system according to claim 8, wherein users of one or more of the plurality of devices respond to the distributed content.

14. A computer readable medium having computer readable program for operating on a computer for displaying content on multiple third party viewable screens over a network, said program comprising instructions that cause the computer to perform the steps of:
establishing an identity on the network and associating the identity with an identifier;
uploading content onto the network using an apparatus;
associating the content with the identifier; and
distributing and projecting the uploaded content and the identifier to a plurality of devices simultaneously.

15. The program according to claim 14, wherein the apparatus is one of a mobile device, a game controller, iTV, and a computer.

16. The program according to claim 14, wherein each of the plurality of devices is one of a mobile device, a game controller, iTV, a TV, an event big screen, and a computer.

17. The program according to claim 14, wherein the content is at least one of text, SMS, email, and a voice message.

18. The program according to claim 14, wherein the identifier is one of an avatar, a picture, a graphical icon, and guest.

19. The program according to claim 14, wherein the step of establishing an identity further comprises steps of:
logging-in to the network;
registering; and
selecting the identifier.

20. The program according to claim 14, wherein users of one or more of the plurality of devices respond to the distributed content.
